(19) United States
(12) Patent Application Publication
(10) Pub. No.: US 2011/0314648 A1
(43) Pub. Date: Dec. 29, 2011

(54) COFFIN, WHICH HAS KINDLY ENVIRONMENT MEANS

(75) Inventor: Bendt Skov, Copenhagen O (DK)

(73) Assignee: BECO CONSULT APS, Copenhagen Ø (DK)

(21) Appl. No.: 13/254,973

(22) PCT Filed: Sep. 18, 2009
(86) PCT No.: PCT/DK2009/000207

§ 371 Date: Sep. 6, 2011

(30) Foreign Application Priority Data
Mar. 7, 2009 (DK) BA 2009 00049

(51) Int. Cl. A61G 17/007; A61G 17/02

(52) U.S. Cl. 27/14

(57) ABSTRACT

Coffin (2), which in its shape, function and its choice of material has a kind environment, but still is stabile, and with a lit (1), which in its design has means (7) for by an earth filling (6) to be able to be discharge (5) in to the coffin (2) and down against the body (4) there has to be buried, as the lid (1) in its edges (3) has a folding arrangement (7).

### THE AREA OF THE USE OF THE INVENTION

The invention concern a coffin, which in its design, function and in its choice of material has kindly environment means.

### KNOWN TECHNIQUE

Hitherto it is known to have coffin according to among other things the Danish document of an utility-model DK 2000 00282, where there is shown a two spited coffin, with an outer an inner coffin, where the lid in the inner coffin, has to be displaced down into the coffin, but first after that one has dismounted one or more vertical placed holding—or distance plugs between the two coffins.

The disadvantage is for the first that one used wood, which in this version is expensive, and that it only very difficult over time has to be perished by putrefaction, which very well could last half to whole a year. And where following the burial place shall be filled up with earth, because the earth has to be sunken down by the crashing of the coffin.

The disadvantage is next that one use an inner coffin and a outer coffin, and even one relieve the two coffins, then will a following crashing of the lid only very difficult be displaced into the coffin, and it will immediate not in the mentioned version be able to be shaped compact to and down tight over the body.

### THE TECHNICAL PROBLEM, WHICH SHALL BE SOLVED

With the invention one want to make an arrangement of coffin, of the mentioned sort, where one for the first can establish or make an arrangement of coffin, which is essential cheaper than earlier, in the same time with that this by this will be more kindly of the environment, and where it by its design get such functions, that one generally can avoid that the earth on the place of burial, after some time, after the funeral, are sinking.

### THE NEW TECHNIQUE

The new is, that the lid in its design has means for, by an earth filling to be able to be displaced into the coffin, and down against the body there has been funeral, as the lid in its edges has folding arrangements.

One obtain by this that the lid by an earth filling, with a reasonable mass and inertia from the mass, which most surpass the weight from flowers and their laying,—will clap together and be displaced into the coffin itself.

The new is also that the folding arrangement is shaped as an in turned “bellow of an accordion”.

One obtains by this that there by a pressure down on the top of the lid and the sides, and then will these be able to be moved and given in the bellows. This will specially work, when one throw earth on the lid, by which the inertia of the earth or the moving energy will give its energy to the lid and the arrangement of the bellow, and get these, pushed and guided down in to the coffin and over the body itself.

The new is also that the bottom of the coffin is equipped with u-shaped and along going ribs.

One obtains by this that the coffin itself will be stabilised for bending and crack.

The new is also that the sides of the coffin are equipped with vertical going u-shaped ribs.

One obtains by this that the sides on the coffin do not will be able to fold together in vertical direction, but will be more stabilised.

The new is also that the box itself of the coffin has to be made in more sections as 2 identical sections which have be coupled together, or 3 sections, which have to be coupled together with a middle section, and where the ends are identical.

One obtains by this that it will be cheaper to made moulds for paper pulp, as the mould will be identical for the two ends, and in the same time will the mould be shorter, which of course also is valid for a middle section, if the coffin has to be made of tree sections.

The coffin could on this way also be made in two different lengths, with and without a middle section.

The new is also that the arrangement of the coffin has to be made of paper pulp or like perishable material of refuse.

One obtains by this that the coffin both will be cheaper in production, and in the same time with that it will be destroyed very fast. And further it will be much more kindly according to the environment.

### THE LIST OF FIGURES

The invention shall after this be explained nearer under reference to the drawing, where

FIG. 1 shows in a cut a coffin 2, where there in this 2 is a body 4, and where one can see, how the lid 1 by a filling with earth 6 is going down and around above the person 4.

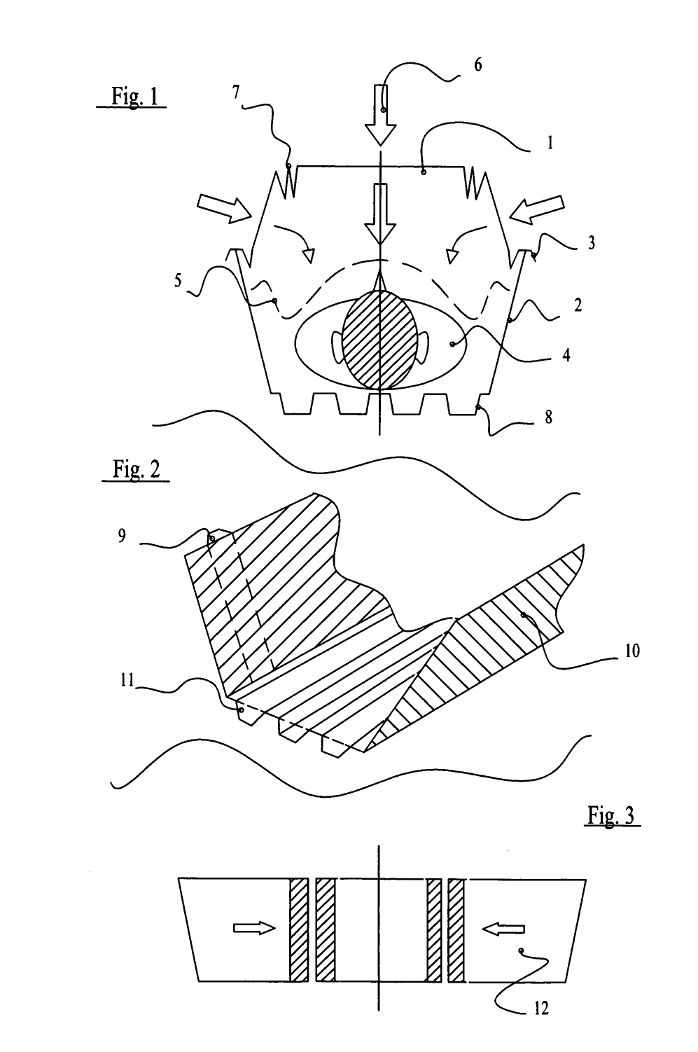

It can be seen very clearly, how one has made the lid 1, so that lid 1 itself automatic by the filling with earth 6 will through down in the coffin 2, and fold up around 5 and over the person 4.

Of the drawing one can also see, how the lid 1 on the edge 3 has en down going board 3, which guide the lid 1 so that it 1 in the first time do not will slip the sides 10.

The lid 1 could if it necessary also be equipped with a locking—or a clicking arrangement, which arrangement also is known from eggs boxes, and where one close the eggs box by some knops, which can be pushed into some corresponding holes.

In the lid 1 could one alternative possible think to place pins through the bellows 7, so that even a heavy laying 6 or dumping 6 of flowers on lid 1 of the coffin 2 do not will be able to displace the lid 1 down in the coffin itself 2. Alternative one could think a locking arrangement a la the earlier mentioned height knops, which is known from eggs-boxes.

The bottom could also be equipped with profiles 8 with long going ribs 8, so that this could give some stabilise of the body of the coffin 2 itself, and specially, if the coffin 2 shall be lifted with a weight 4 in it 2.

One could think to mount two long going beams out on, or at edges, or between heights on two ribs 11, and these beams laid respectively in the right as in the left side.

The handles for lift could ideally so be mounted on these beams.

The beams could even be removed by, that one, when the coffin 2 has been sunken down,—then could one as an example through these out to each sides.

One could also only leave them, where they are. Alternative could one made long going beams in millboard or paper or like.

FIG. 2 shows in a cut and in perspective a profile of the coffin 2, and where one clearly here can see the long going profiles 11 or ribs 11 in the bottom, and the vertical profiles 9 or ribs 9 on the sides of the coffin 2.

The profiles 8, 9 and 11 do, as earlier mentioned, that the coffin 2 itself will be more stabile, and that it 2 can hold to be lifted with a load 4, without to be able to collapsed or to break.

FIG. 3 shows, and seen form the side, a coffin 2 made of 3 sections 12, where the two end-parts generally are identical, and where the middle parts gather the coffin 2 itself together.

1. Coffin (2), which in its shape, function and its choice of material has a kind environment, but still is stabile, and with a lit (1), which in its design has means (7) for by an earth filling (6) to be able to be discharge (5) in to the coffin (2) and down against the body (4) there has to be buried, characteristic of, that the lid (1) in its edges (3) has a folding arrangement (7).

2. Coffin (2) made with kind environment properties according to claim 1, characteristic of, that the folding arrangement (7) is shaped or designed as an inside turned bellow (7) of an accordion.

3. Coffin (2) made with kind environment properties according to claim 1, characteristic of, that the bottom of the coffin (2) is equipped with u-shaped (11/8) and long going ribs (11/8).

4. Coffin (2) made with kind environment properties according to claim 1, characteristic of, that sides (10) of the coffin (2) are equipped with vertical u-shaped ribs (9).

5. Coffin (2) made with kind environment properties according to claim 1, characteristic of, that the box itself of the coffin (2) is made of more sections as 2 equal sections, which are gathered, or 3 sections, which are gathered with a middle section, and where the ends (12) are equal.

6. Coffin (2) made with kind environment properties according to claim 1, characteristic of, that the arrangement of the coffin (2) is made of paper pulp or like perishable material of waste matter.
